(19) United States
(12) Patent Application Publication
(10) Pub. No.: US 2013/0272409 A1
(43) Pub. Date: Oct. 17, 2013

(54) BANDWIDTH REDUCTION IN VIDEO CODING THROUGH APPLYING THE SAME REFERENCE INDEX

(71) Applicant: QUALCOMM INCORPORATED, San Diego, CA (US)

(72) Inventors: Vadim SEREGIN, San Diego, CA (US); Muhammed Zeyd COBAN, Carlsbad, CA (US); Xianglin WANG, San Diego, CA (US); Jianle CHEN, San Diego, CA (US); Marta KARCZEWICZ, San Diego, CA (US)

(73) Assignee: QUALCOMM Incorporated, San Diego, CA (US)

(21) Appl. No.: 13/860,314

(22) Filed: Apr. 10, 2013

Related U.S. Application Data
(60) Provisional application No. 61/623,499, filed on Apr. 12, 2012.
(60) Provisional application No. 61/710,556, filed on Oct. 5, 2012.

(51) Int. Cl. H04N 11/02

(52) U.S. Cl. CPC H04N 19/0066
USPC 375/240.16

(57) ABSTRACT

Techniques for encoding and decoding video data are described. A method of coding video may include determining a plurality of motion vector candidates for a block of video data for use in a motion vector prediction process, wherein each of the motion vector candidates points to a respective reference frame index, performing the motion vector prediction process using the motion vector candidates to determine a motion vector for the block of video data, and performing motion compensation for the block of video data using the motion vector and a common reference frame index, wherein the common reference frame index is used regardless of the respective reference frame index associated with the determined motion vector.

This application claims the benefit of U.S. Provisional Application No. 61/623,499, filed Apr. 12, 2012 and U.S. Provisional Application No. 61/710,556, filed Oct. 5, 2012, the entire content of each of which is incorporated herein by reference.

### TECHNICAL FIELD

This disclosure relates to video coding, and more particularly to video coding techniques for reducing memory bandwidth requirements in a video decoder and/or video encoder.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques for inter prediction in a video coding process. In one example of the disclosure, a method of decoding and/or encoding video data may comprise determining a plurality of motion vector candidates for a block of video data for use in a motion vector prediction process, wherein each of the motion vector candidates points to a respective reference frame index, performing the motion vector prediction process using the motion vector candidates to determine a motion vector for the block of video data, and performing motion compensation for the block of video data using the motion vector and a common reference frame index, wherein the common reference frame index is used regardless of the respective reference frame index associated with the determined motion vector.

The techniques of this disclosure are also described in terms of an apparatus (e.g., a video encoder and/or a video decoder) and a computer-readable storage medium storing instructions for causing a processor to perform the techniques.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating spatial and temporal neighboring blocks from which motion vector predictor candidates are generated for motion vector prediction modes.

FIG. 3A is a conceptual diagram showing an example where a common reference frame is positioned temporally before a current frame, and a reference frame of a motion vector candidate is positioned temporally after the current frame.

FIG. 3B is a conceptual diagram showing an example where a reference frame of a motion vector candidate is positioned temporally before a current frame, and a common reference frame is positioned temporally after the current frame.

FIG. 4 is a conceptual diagram showing an example temporal distance between a common reference frame and the reference frame of a motion vector candidate.

FIG. 5 is a block diagram illustrating an example video encoder that may implement the techniques described in this disclosure.

FIG. 6 is a block diagram illustrating an example video decoder that may implement the techniques described in this disclosure.

FIG. 7 is a block diagram showing an example memory structure according to one example of the disclosure.

FIG. 8 is a flowchart showing an example method of video encoding and decoding according to the techniques of the disclosure.

### DETAILED DESCRIPTION

In general, digital video devices implement video compression techniques to transmit and receive digital video information more efficiently. Video compression may apply spatial (intra-frame) prediction and/or temporal (inter-frame) prediction techniques to reduce or remove redundancy inherent in video sequences.

During video decoding, a video decoder may store a copy of a reference picture identified by the signaled reference index (refldx) in a local cache. Reference pictures are used in a motion compensation process (also called inter-frame prediction, or inter prediction). Often, if the reference picture changes between blocks of video data being decoded, a video decoder may have to access another reference picture from memory and store it in local cache for decoding. In some circumstances (e.g., in mobile devices), the size of the local cache may be small, and as such, may only be able to store a limited number of reference pictures. Constantly accessing new reference pictures for storage into the local cache may limit the speed of the video decoder and may require extensive bandwidth for memory access. In this context, memory bandwidth may refer to the speed at which data can be accessed from memory, and may be related to the speed of the memory bus.

In view of these drawbacks, this disclosure proposes techniques for reducing memory bandwidth requirements in a video coding process. In real coder/decoder implementations, it is desirable to reduce bandwidth requirements (e.g., bandwidth for memory access). This disclosure proposes techniques to reduce bandwidth requirements by reducing the need to access reference pixels not currently stored in a local cache (e.g., pixels in reference pictures). The techniques of this disclosure seek to maintain a good tradeoff between bandwidth reduction and coding performance.

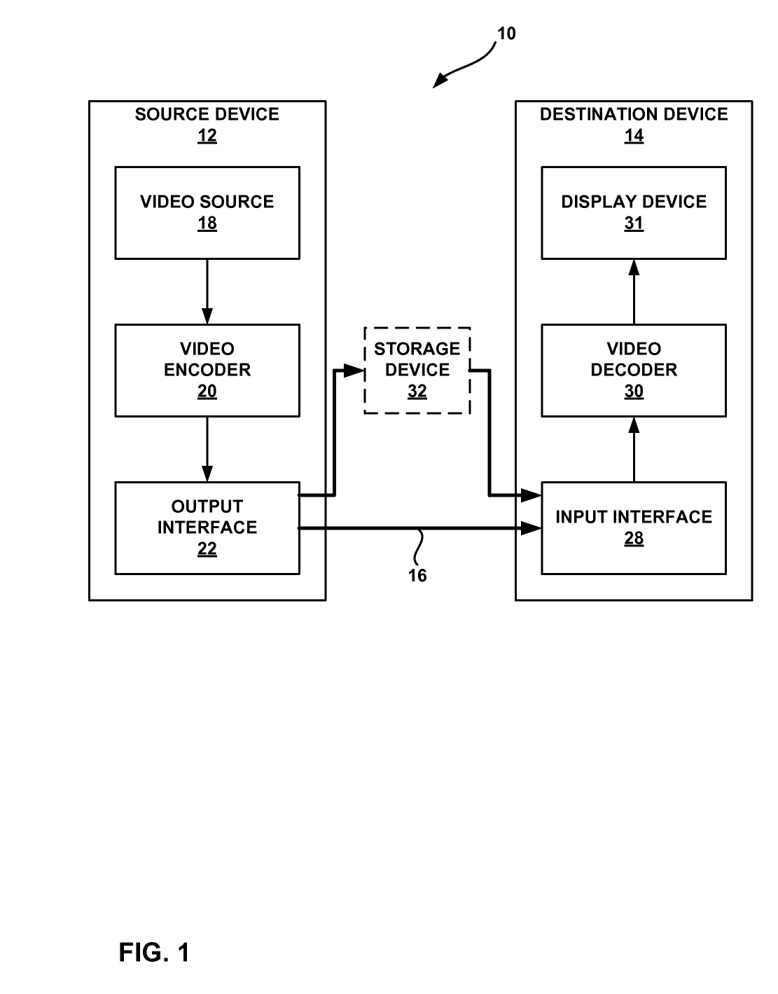

FIG. 1 is a block diagram illustrating an example video encoding and decoding system 10 that may utilize the techniques for bandwidth reduction described in this disclosure. As shown in FIG. 1, system 10 includes source device 12 that generates encoded video data to be decoded at a later time by destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded data may be output from output interface 22 to storage device 32. Similarly, encoded data may be accessed from storage device 32 by input interface 28. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure for reducing memory bandwidth requirements in video coding are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20 and output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes input interface 28, video decoder 30, and display device 31. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 31 may be integrated with, or external to, destination device 14. In some examples, destination device 14 may include an integrated display device and also be configured to interface with an external display device. In other examples, destination device 14 may be a display device. In general, display device 31 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

As will be explained in more detail below, utilizing the techniques of this disclosure, video decoder 30 may be configured to determine a plurality of motion vector candidates for a block of video data for use in a motion vector prediction process, wherein each of the motion vector candidates points to a respective reference frame index, perform the motion vector prediction process using the motion vector candidates to determine a motion vector for the block of video data, and perform motion compensation for the block of video data using the motion vector and a common reference frame index, wherein the common reference frame index is used regardless of the respective reference frame index associated with the determined motion vector.

Likewise, video encoder 20 may be configured to determine a plurality of motion vector candidates for a block of video data for use in a motion vector prediction process, wherein each of the motion vector candidates points to a respective reference frame index, perform the motion vector prediction process using the motion vector candidates to determine a motion vector for the block of video data, and perform motion compensation for the block of video data using the motion vector and a common reference frame index, wherein the common reference frame index is used regardless of the respective reference frame index associated with the determined motion vector.

The emerging HEVC standard is currently under development by the Joint Collaborative Team on Video Coding (JCT-VC) of ITU-T Video Coding Experts Group (VCEG) and ISO/IEC Motion Picture Experts Group (MPEG). The HEVC process is described in a Working Draft (referred to as HEVC WD6 hereinafter), entitled “High efficiency video coding (HEVC) text specification draft 6,” Bross et al., JCTVC-H1003, presented at Joint Collaborative Team on Video Coding (JCT-VC) of ITU-T SG16 WP3 and ISO/IEC JTC1/SC29/WG11, 8th Meeting: San Jose, Calif., USA, 1-10 Feb. 2012. A more recent draft of the HEVC standard, referred to as “HEVC Working Draft 9” or “WD9,” is described in document JCTVC-K1003v13, Bross et al., “High efficiency video coding (HEVC) text specification draft 9,” Joint Collaborative Team on Video Coding (JCT-VC) of ITU-T SG16 WP3 and ISO/IEC JTC1/SC29/WG11, 11th Meeting: Shanghai, Conn., 10-19 Oct. 2012, which, as of Mar. 19, 2013, is downloadable from http://phenix.int-evry.fr/jct/doc_end_user/documents/11_Shanghai/wg11/JCTVC-K1003-v13.zip. The entire content of HEVC WD6 and WD9 are hereby incorporated herein by reference.

The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

For video coding according to the HEVC standard currently under development, a video frame may be partitioned into coding units, prediction units and transform units. A coding unit (CU) generally refers to an image region that serves as a basic unit to which various coding tools are applied for video compression. A coding unit is typically rectangular, and may be considered to be similar to a so-called macroblock, e.g., under other video coding standards such as ITU-T H.264.

A CU usually has one luminance component, denoted as Y, and two chroma components, denoted as U and V. Depending on the video sampling format, the size of the U and V components, in terms of number of samples, may be the same as or different from the size of the Y component.

To achieve better coding efficiency, a CU may have variable sizes depending on video content. In addition, a coding unit may be split into smaller blocks for prediction or transform. In particular, each coding unit may be further partitioned into prediction units and transform units. Prediction units (PUs) may be considered to be similar to so-called partitions under other video coding standards, such as H.264. Transform units (TUs) refer to blocks of residual data to which a transform is applied to produce transform coefficients.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into CUs according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and PUs and TUs associated with the coding node. A size of the CU generally corresponds to a size of the coding node and must typically be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The emerging HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU may be used for the transform and quantization processes. A given CU having one or more PUs may also include one or more transform units (TUs). Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients. Techniques of inter-prediction will be discussed in more detail below.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

To code a block (e.g., PU of video data), a predictor for the block is first derived. The predictor can be derived either through intra (I) prediction (i.e., spatial prediction) or inter (P or B) prediction (i.e., temporal prediction). The process of inter prediction is sometimes called motion compensation. Coding video data according to HEVC may involve some PUs being intra-coded (I) using spatial prediction with respect to neighboring reference blocks in the same frame, and other PUs being inter-coded (P or B) with respect to reference blocks in other frames. Techniques for inter prediction will now be discussed in more detail.

Inter prediction involves the use of motion vectors. A motion vector may indicate the displacement of a PU in a current frame relative to a reference sample of a reference frame. A reference sample may be a block that is found to closely match the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

Encoded data defining the motion vector may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., list 0 (L0), list 1 (L1) or a combined list (LC)) for the motion vector, e.g., as indicated by a prediction direction. A reference index (ref_idx) may identify the particular picture in the reference picture list (L0, L1 or LC) to which the motion vector points. In this manner, the ref_idx syntax element serves as an index into a reference picture list, i.e., L0, L1 or LC. Data for the leaf-CU defining the PU(s) may also describe, for example, partitioning of the CU into one or more PUs. Partitioning modes may differ depending on whether the CU is uncoded, intra-prediction mode encoded, or inter-prediction mode encoded. For intra coding, a PU may be treated the same as a leaf transform unit described below.

Video encoder 20 may perform a process commonly referred to as “motion estimation” to determine a motion vector for each PU encoded using inter prediction. Video encoder 20 determines these motion vectors by, as one example, performing what may be referred to as a “motion search” in a reference frame, where video encoder 20 searches for each block in either a temporally subsequent or future reference frame. Upon finding a block of the reference frame that best matches the current block (e.g., a PU), video encoder 20 determines the current motion vector for the current block as the difference in the location from the current block to the matching block in the reference frame (e.g., from the center of the current block to the center of the matching block).

In some examples, video encoder 20 may signal the motion vector for each block in the encoded video bitstream. The signaled motion vector is used by video decoder 30 to perform motion compensation in order to decode the video data. However, signaling the entire motion vector may results in less efficient coding, as the motion vectors are typically represented by a large number of bits.

In some instances, rather than signal the entire motion vector, video encoder 20 may predict a motion vector for each block using a motion vector prediction process. In performing a motion vector prediction process, video encoder 20 may select a set of candidate motion vectors (or motion vector associated with candidate blocks) determined for spatially neighboring blocks (e.g., neighboring PUs or CUs) in the same frame as the current block or a candidate motion vector determined for a co-located block in another reference frame. Video encoder 20 may perform motion vector prediction rather than signal an entire motion vector to reduce complexity and bit rate in signaling.

Two different modes or types of motion vector prediction are proposed for use in HEVC. One mode is referred to as a “merge” mode. The other mode is referred to as advanced motion vector prediction (AMVP). In merge mode, video encoder 20 instructs a decoder (e.g., video decoder 30), through bitstream signaling of prediction syntax, to copy a motion vector, reference index (ref_idx; a syntax element identifying a reference frame, in a given reference picture list, to which the motion vector points) and the motion prediction direction (which identifies the reference picture list, i.e., in terms of whether the reference frame temporally precedes or follows the currently frame) from a selected candidate motion vector for a current block of the frame. This is accomplished by signaling in the bitstream an index (mvp_idx) identifying the candidate portion having the selected candidate motion vector. Thus, for merge mode, the prediction syntax may include a flag identifying the mode (in this case “merge” mode) and an index identifying the particular of motion vector candidate from which to borrow the motion prediction information.

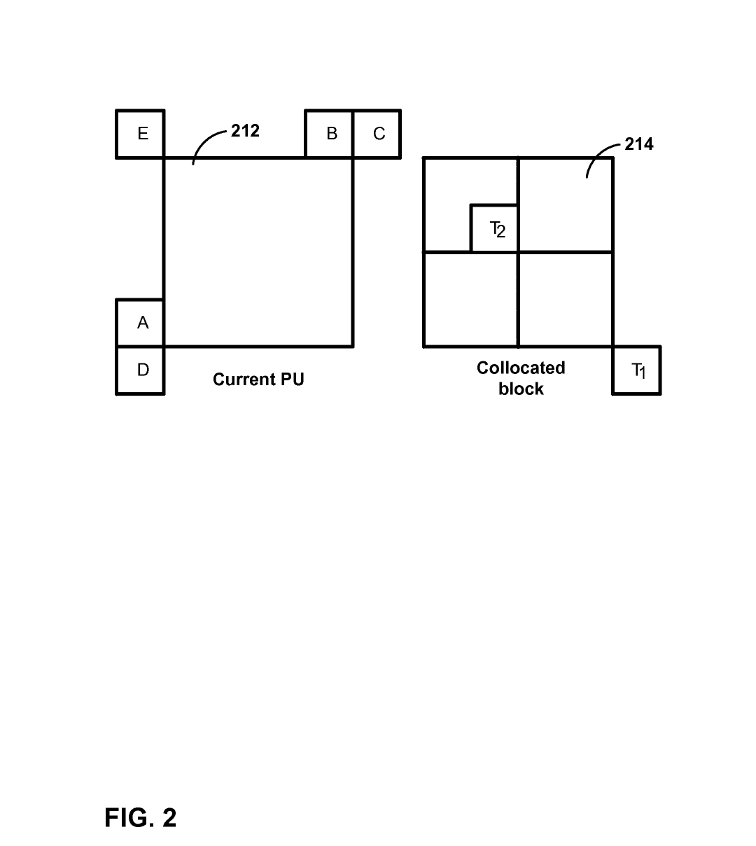

FIG. 2 is a conceptual diagram illustrating spatial and temporal neighboring blocks from which motion vector predictor candidates are generated for motion vector prediction modes. In one example proposal for HEVC, both merge and AMVP mode uses the same motion vector predictor candidate list from which to determine a motion vector for a current video block or PU 212. The motion vector predictor candidates in the merge mode and AMVP mode may include motion vectors for spatial neighboring blocks of current PU 212, for example, neighboring blocks A, B, C, D and E illustrated in FIG. 2. The motion vector predictor candidates may also include motion vectors for temporal neighboring blocks of a collocated block 214 of current PU 212, for example, neighboring blocks T₁ and T₂ illustrated in FIG. 2. A collocated block is a block in a different picture than the currently coded block. In some cases, the motion vector predictor candidates may include combinations of motion vectors for two or more of the neighboring blocks, e.g., an average, median, or weighted average of the two or more motion vectors.

In some instances, the candidate block will be a causal block in reference to the current block. That is, the candidate block will have already been coded by video encoder 20 and/or video decoder 30. As such, for example, video decoder 30 has already received and/or determined the motion vector, reference index, and motion prediction direction for the candidate block. As such, video decoder 30 may simply retrieve the motion vector, reference index, and motion prediction direction associated with the candidate block from memory, and copy these values for the current block.

In AMVP, video encoder 20 instructs video decoder 30, through bitstream signaling, to only copy the motion vector from the candidate block, and signals the reference frame (ref_idx) and the prediction direction separately. In AMVP, the motion vector to be copied may be signaled by sending a motion vector difference (MVD). A MVD is the difference between the current motion vector for the current block and a candidate motion vector for a candidate block. In this way, video decoder 30 need not use an exact copy of the candidate motion vector for the current motion vector, but may rather use a candidate motion vector that satisfies some predetermined rate-distortion criteria. The selected candidate motion vector is then added the MVD to reproduce the current motion vector.

In most circumstances, the MVD requires fewer bits to signal than the entire current motion vector. As such, AVMP allows for more precise signaling of the current motion vector while maintaining coding efficiency over sending the whole motion vector. In contrast, the merge mode does not allow for the specification of an MVD, and as such, merge mode sacrifices accuracy of motion vector signaling for increased signaling efficiency (i.e., fewer bits). The prediction syntax for AVMP may include a flag for the mode (in this case AMVP), the index for the candidate portion (mvp_idx), the MVD between the current motion vector and the candidate motion vector for the candidate portion, the reference index (ref_idx), and the motion prediction direction.

Once motion estimation is performed to determine a motion vector for each of the portions, the encoder compares the matching portion in the reference frame (if a motion search was performed) or the portion of the reference frame identified by the predicted motion vector (if motion vector prediction was performed) to the current portion. This comparison typically involves subtracting the portion (which is commonly referred to as a “reference sample”) in the reference frame from the current portion and results in so-called residual data. The residual data indicates pixel difference values between the current portion and the reference sample. The encoder then transforms this residual data from the spatial domain to the frequency domain. Usually, the encoder applies a discrete cosine transform (DCT) to the residual data to accomplish this transformation. The encoder performs this transformation in order to further compress the residual data as the resulting transform coefficients need only be encoded after the transformation rather than the residual data in its entirety.

Typically, the resulting transform coefficients are grouped together in a manner than enables run-length encoding, especially if the transform coefficients are first quantized (rounded). The encoder performs this run-length encoding of the quantized transform coefficients and then performs statistical lossless (or so-called “entropy”) encoding to further compress the run-length coded quantized transform coefficients.

After performing lossless statistical coding, the encoder generates a bitstream that includes the encoded video data. This bitstream also includes a number of prediction syntax elements in certain instances that specify whether, for example, motion vector prediction was performed, the motion vector mode, and a motion vector predictor (MVP) index (i.e., the index of the candidate portion with the selected motion vector). The MVP index may also be referred to as its syntax element variable name “mvp_idx.”

During video decoding, in order to perform a motion vector prediction process and any subsequent motion compensation, video decoder 30 may store a copy of the reference picture identified by the signaled reference index (ref_idx) in a local cache. Often, if the reference picture changes between blocks being decoded, video decoder 30 may have to access another reference picture from memory and store it in local cache for decoding. In some circumstances (e.g., in mobile devices), the size of the local cache may be small, and may only be able to store a limited number of reference pictures. Constantly accessing new reference pictures for storage into the local cache may limit the speed of video decoder 30 and may require extensive bandwidth for memory access. Memory bandwidth may refer to the speed at which data can be accessed from memory, and may be related to the speed of the memory bus.

In view of these drawbacks, this disclosure proposes techniques for reducing memory bandwidth requirements in a video coding process. In real coder/decoder implementations, it is desirable to reduce bandwidth requirements (e.g., bandwidth for memory access). This disclosure proposes techniques to reduce bandwidth requirements by reducing the need to access unstored reference pixels (e.g., in reference pictures). The techniques of this disclosure seek to maintain a good tradeoff between bandwidth reduction and coding performance.

This disclosure proposes techniques for bandwidth reduction in a video coding process. In particular, the techniques of this disclosure may be used with the current HEVC test model (HM). In real coder/decoder implementations, it is desirable to reduce bandwidth requirements. This disclosure proposes techniques to reduce bandwidth requirements by reducing the need to access unstored reference pixels. The techniques of this disclosure seek to maintain a good tradeoff between bandwidth reduction and coding performance.

According to one example of the disclosure, bandwidth reduction is achieved by limiting the usage of different reference indexes, and thus limiting the number of reference frames. According to this example, reference pixels for inter-prediction may be restricted to a predetermined number of different reference indices. In one specific example, only one reference index is used. In this example, all reference pixels for a certain amount of video data (e.g., one frame or one block) will be fetched from the same reference frame (i.e., the reference frame indicated by the reference index). By restricting the reference index to one value, and thus restricting the number of possible reference frames to one for a certain amount of video data, the chance that the reference pixels will have already been stored in a cache is increased. As such, memory bandwidth requirements will be reduced as fewer fetches from main memory and storage to local cache will be needed.

A reference picture to be used for inter-prediction is identified by a reference index of the reference picture list. Using only one reference index for a particular amount of data means that only one reference picture is used. So, an alternative way to implement the techniques of this disclosure may involve only using one reference picture for inter-prediction for a particular amount of data (e.g. a frame or a block), or more specifically, only one reference picture with a particular POC can be used. Since the reference picture is identified by reference index, for illustrative purposes, this disclosure will be described using the reference index terminology. However, as mentioned above, it can be equally described in terms of reference pictures themselves or reference picture POCs.

As one example, video encoder 20 and video decoder 30 may be configured to use the same reference index when performing a motion vector prediction process for a predetermined number of PUs and/or for certain sizes of PUs (e.g., PUs of a certain size, and/or PUs in a certain area, e.g., one frame). This “same” reference index may be referred to as a common reference frame index (common_refIdx). Alternatively, instead of using a common reference index, the techniques of this disclosure may be implemented using a common reference picture or common reference picture POC.

In some instances, during merge list construction, the reference index of the MV candidate maybe not equal to the common_refIdx (i.e., the common reference frame index chosen to be used for that PU). In this case, the reference index of MV candidate may be changed to the chosen common_refIdx. In another example, only the reference index of the motion vector candidate, used for the prediction and signaled with the merge index in a bitstream, is changed to be the common_refIdx.

In some examples, video encoder 20 and video decoder 30 may be configured to change the reference index of a motion vector candidate to be the common reference frame index without changing or altering the motion vector of the MV candidate.

In another example of the disclosure, video encoder 20 and video decoder 30 may be configured to flip the sign of a motion vector of an MV candidate (e.g., multiply the motion vector by −1) if the reference frame of the MV candidate and the common reference frame (i.e., the common reference frame chosen to be used for the currently coded PU) are located on different sides of current frame (i.e., one reference frame is from the backward direction relative to the current frame and the other reference frame is from the forward direction relative to the current frame).

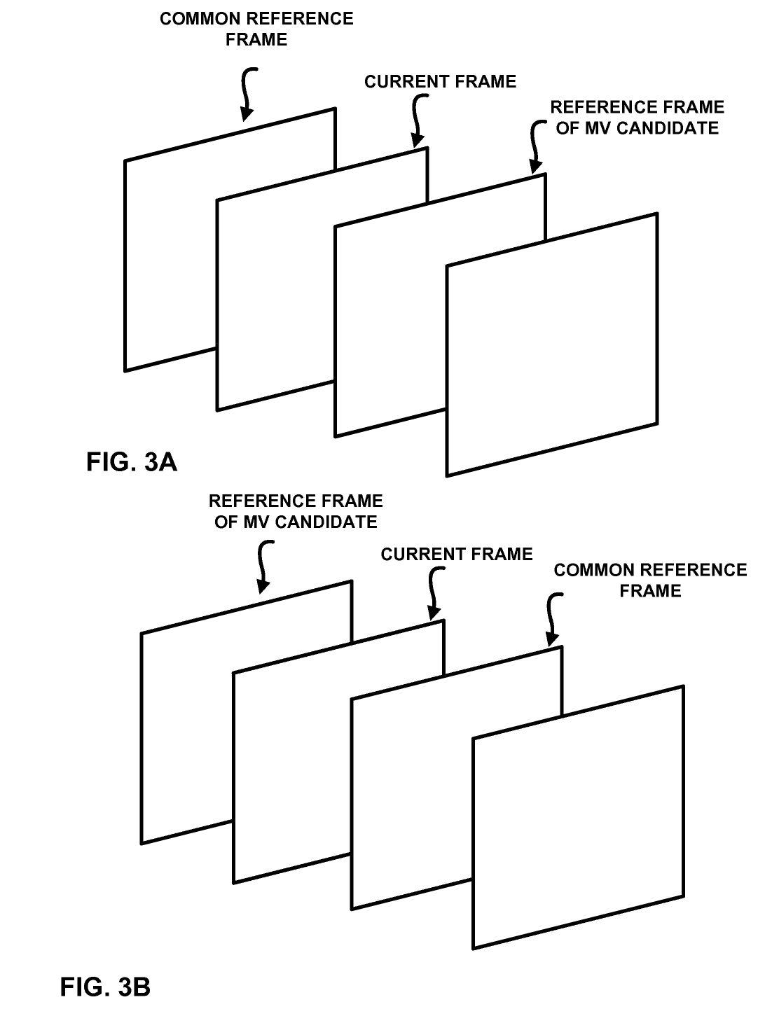

FIG. 3A and FIG. 3B show examples of such a situation. In FIG. 3A the common reference frame is positioned temporally before the current frame (i.e., the frame containing the currently coded PU). However, the reference frame of the MV candidate selected and/or signaled as a result of the motion vector prediction process is located temporally after the current frame. In this case, the motion vector associated with the MV candidate would be multiplied by −1, and then used as the motion vector for the currently coded PU in a motion compensation process. FIG. 3B shows the example, where the reference frame of the MV candidate is located temporally before the current frame, and the common reference frame is located temporally after the current frame. In this example as well, the motion vector associated with the MV candidate would be multiplied by −1, and then used as the motion vector for the currently coded PU in a motion compensation process.

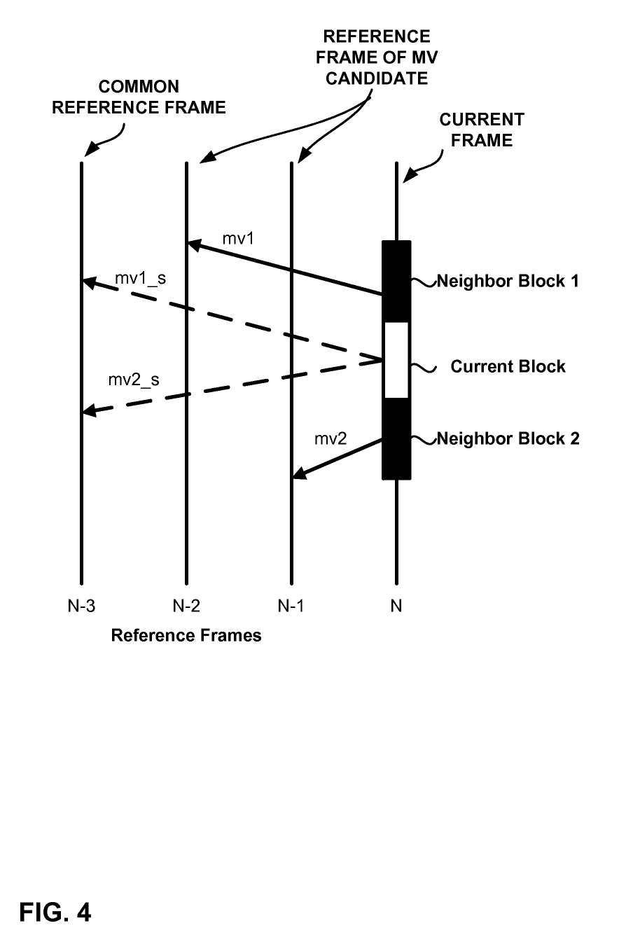

In another example of the disclosure, the motion vector of an MV candidate can be scaled according to the temporal distance between the pictures identified by the MV candidate reference index and the reference picture identified by the common reference index. FIG. 4 is a conceptual diagram showing an example temporal distance between a common reference frame and the reference frame of an MV candidate. As shown in FIG. 4, the currently coded block (e.g., a PU) resides in the current frame N. Two or more spatial MV candidates (neighbor block 1 and neighbor block 2) also reside in the current frame N. Neighbor block 1 and neighbor block 2 may be MV candidates for a motion vector prediction process, such as merge mode. In this example, neighbor block 1 has a motion vector (mv1) that points to reference frame N−2. Neighbor block 2 has a motion vector (mv2) that points to the reference frame N−1. However, the common reference frame is at frame N−3. The temporal distance between the reference frame of an MV candidate and the common reference frame may be used to scale the motion vector of a selected MV candidate (e.g., selected as the candidate to be used in merge mode for the current block. Temporal distance between frames is sometimes referred to as a picture order count (POC) distance.

When scaling a motion vector according to a POC distance, a scaling factor (e.g., DistScaleFactor) is used. As one example, the scaling factor DistScaleFactor is defined by:

DistScaleFactor=(POC_{curr}−POC_{ref})/(POCₘᵥₚ_{_{—}}_{blk}−POCₘᵥₚ_{_{—}}_{blk}_{_{—}}_{ref})=tb/td (1)

POC_{curr} is the POC for the block being coded. In the example of FIG. 4, POC_{curr} would be the POC for current frame (N). POC_{ref} is the POC for the reference block to which the motion vector will be scaled. In the example of FIG. 4, POC_{ref} is the POC of the common reference frame (N−3). POCₘᵥₚ_{_{—}}_{blk} is the POC for the MV candidate chosen as the motion vector predictor (MVP). In the example of FIG. 4, both neighbor block 1 and neighbor block 2 have a POCₘᵥₚ_{_{—}}_{blk} of the current frame (N). POCₘᵥₚ_{_{—}}_{blk}_{_{—}}_{ref} is the POC for the reference block of the MVP. In the example of FIG. 4, neighbor block 1 has a POCₘᵥₚ_{_{—}}_{blk}_{_{—}}_{ref} of N−2, while neighbor block 2 has a POCₘᵥₚ_{_{—}}_{blk}_{_{—}}_{ref} of N−1. The variable td is the POC distance between the MVP and its reference block, and tb is the POC distance between the current block and its reference block (in this example, the common reference block). The scaling factor DistScaleFactor is calculated with integer operation by the following equations:

tx=(16384+Abs(td/2))/td (2)

DistScaleFactor=Clip3(−4096,4095,(tb*tx+32)>>6) (3)

DistScaleFactor may therefore be computed as a function of tb and tx, but clipped to be within a range of −4096 and 4095, as one example. Using this DistScaleFactor, a video coder may scale one or more of the candidate motion vectors in accordance with the following equation (4):

ScaledMV=sign(DistScaleFactor×MV)×((abs(DistScaleFactor×MV)+127))>>8) (4)

ScaledMV denotes a scaled candidate motion vector, MV is the motion vector, “sign” refers to a function that keeps signs, “abs” refers to a function that computes the absolute value of the value and “>>” denotes a bit-wise right shift.

In some examples, both a vertical component and a horizontal component of a motion vector may be scaled. In other examples, it may be desirable to scale only one component (e.g., just the vertical component or just the horizontal component). In other circumstances, both components of the motion vector may be scaled.

Returning to FIG. 4, if the current block were coded to use mv1 as the MVP (e.g., in merge mode), video decoder 20 and video encoder 30 would be configured to scale mv1 to the common reference frame to produce a motion vector (mv1_s). The POC distance between the current frame and reference frames N−2 and N−3 would be used in the equation above (i.e., td=2 and tb=3). Likewise, if the current block were coded to use mv2 as the MVP, video decoder 20 and video encoder 30 would be configured to scale mv2 to produce a motion vector (mv2_s) that points to the common reference frame (reference frame N−3). The POC distance between the current frame and reference frames N−3 and N−1 would be used in the equation above (i.e., td=1 and tb=3). It should be noted that POC-based motion vector scaling may also be based on temporally subsequent frames (e.g., N+1, N+2, etc.), as well as temporally previous frames, as shown in FIG. 4. FIG. 4 is merely one example. Once the motion vector of the motion vector candidate is scaled, the reference index of the MV candidate is set to be the common reference index. The scaling procedure of a motion vector candidate can be applied during merge list construction, or alternatively, be applied only to the candidate which is used for inter prediction and identified by the merge index signaled in the bitstream.

In another example of the disclosure, for AMVP mode, where the reference index for the selected MV candidate is typically signaled, the reference index can be restricted to be a common reference index at video encoder 20. Additionally, signaling of the reference index for particular blocks can be skipped. In this case, video decoder 30 would be configured to use the common reference index for AMVP mode. The common reference index can be fixed to a particular value (e.g., 0, 1, or other possible indices), and both video encoder 20 and video decoder 30 will use the same fixed reference index.

According to another example technique, this disclosure proposes to restrict the number of possible reference indexes (e.g., to a common reference index) only for certain PU sizes. In one example, the number of possible reference indexes is restricted for both uni-directional (e.g., P frames) and bi-directional (e.g., B frames) inter-prediction. As one example size restriction, video encoder 20 and video decoder 30 may be configured to use a common reference index for any inter prediction mode for PUs with a size smaller than 8×8 (e.g., 4×4, 8×4 and 4×8) and/or including 8×8. In another example, restriction to the use of a common reference index may be limited to performing inter prediction (i.e., motion compensation) using an N×N inter prediction mode.

In another example of the disclosure, video encoder 20 may be configured to signal the common reference index that will be used for particular blocks (e.g., a certain set of PUs) in a header. For example, the common reference index may be signaled in one or more of a video parameter set (VPS), picture parameter set (PPS), slice parameter set (SPS), slice header, and an adaptation parameter set (APS). In another example, the common reference index can be signaled at the block level, for example, for every largest coding unit (LCU). For example, when signaled in a picture header, all PUs related to that picture that are coded using inter prediction will use the common reference index. This example technique may also be combined with the technique whereby use of the common reference index is limited to PUs of a certain size, as discussed above.

In another example of the disclosure, video encoder 20 may be configured to signal the common reference index at the level of the largest block that is affected by reference index restriction. For example, if video encoder 20 and video decoder 30 are configured to restrict the use of reference indices to the common reference index for blocks smaller or equal to 8×8, than one common reference index can be signaled per 8×8 block. The signaled common reference index may then be used for any sub-block of this 8×8 block.

The chosen common reference index can be the same for both uni-directional inter prediction (e.g., for list L0) and for bi-directional inter prediction (e.g., for both lists L0 and L1). In another example, two different common reference indices may be used for list L0 and list L1, respectively. All techniques applied for the application of a common reference index discussed above can also be extended to the separate common reference indices for lists L0 and L1. In another example of the disclosure, more than one reference index can be specified for L0 and L1. For example two reference indexes can be used for forward and backward directions.

In another example of the disclosure, only one reference frame associated with the common reference index can be used for both inter prediction directions (i.e., using lists L0 and L1). In this example, the MV candidates referring to another reference frame might be scaled, sign flipped, or just set to be the common reference index, as was described above.

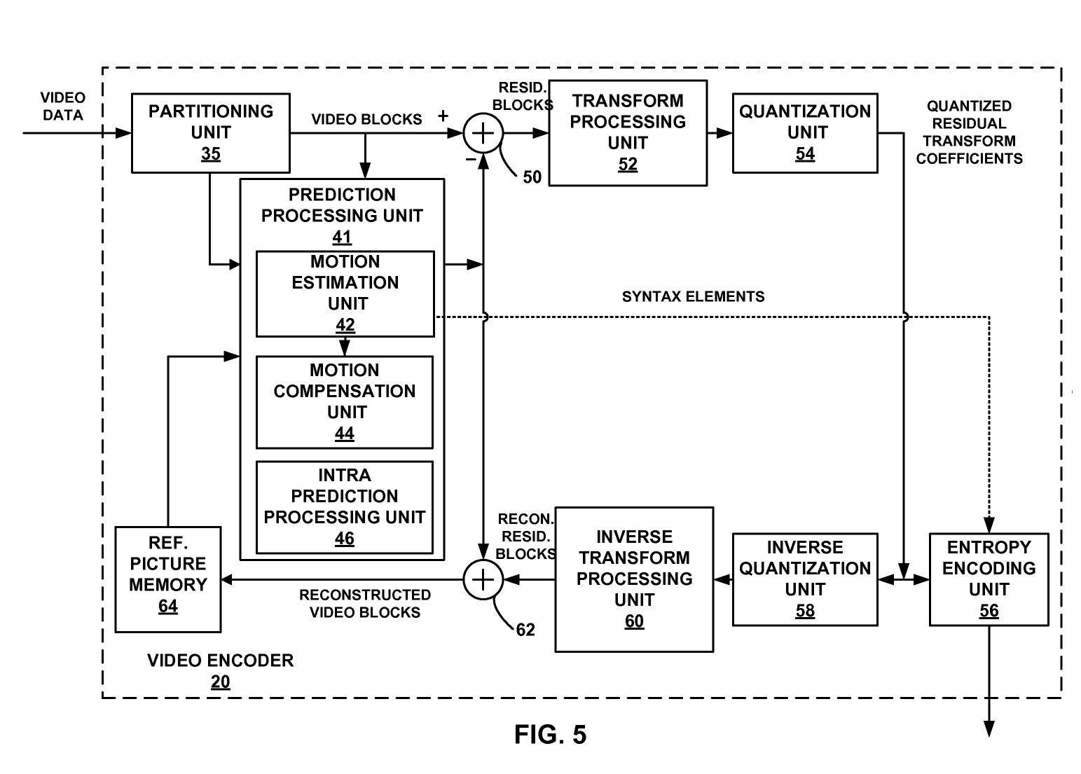

FIG. 5 is a block diagram illustrating an example video encoder 20 that may implement one or more of the techniques for motion vector prediction, motion compensation, and memory bandwidth reduction described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 5, video encoder 20 includes a partitioning unit 35, prediction processing unit 41, reference picture memory 64, summer 50, transform processing unit 52, quantization unit 54, and entropy encoding unit 56. Prediction processing unit 41 includes motion estimation unit 42, motion compensation unit 44, and intra prediction processing unit 46. For video block reconstruction, video encoder 20 also includes inverse quantization unit 58, inverse transform processing unit 60, and summer 62. A deblocking filter (not shown in FIG. 5) may also be included to filter block boundaries to remove blockiness artifacts from reconstructed video. If desired, the deblocking filter would typically filter the output of summer 62. Additional loop filters (in loop or post loop) may also be used in addition to the deblocking filter. For example, sample adaptive offset (SAO) filtering and other types of filtering may also be supported.

As shown in FIG. 5, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

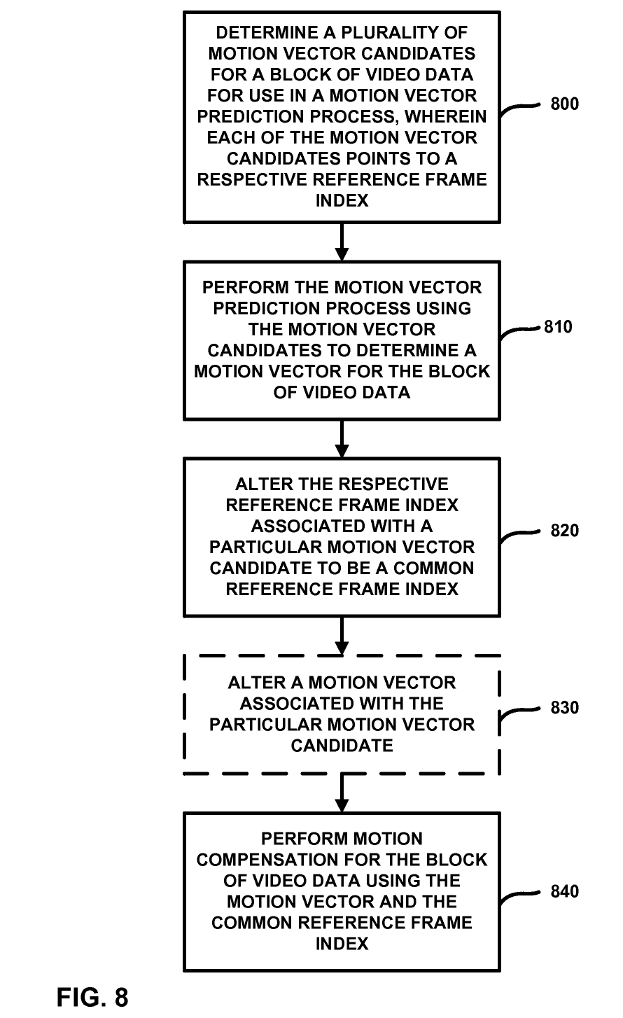

Motion compensation, performed by motion compensation unit 44, may involve fetching or generating the predictive block based on the motion vector determined by motion estimation, possibly performing interpolations to sub-pixel precision. Motion compensation unit 44 may also be configured to perform a motion vector prediction process, such as merge mode or AMVP, to signal motion vector information (i.e., motion vector, reference frame index, prediction direction) in the encoded video bitstream. Upon receiving the motion vector for the PU of the current video block, motion compensation unit 44 may locate the predictive block to which the motion vector points in one of the reference picture lists. In this regard, motion compensation unit 44 may be configured to utilize a common reference frame index according to the techniques of this disclosure. A more detailed discussion of the function of motion compensation unit 44 is discussed below with reference to FIG. 8.

Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

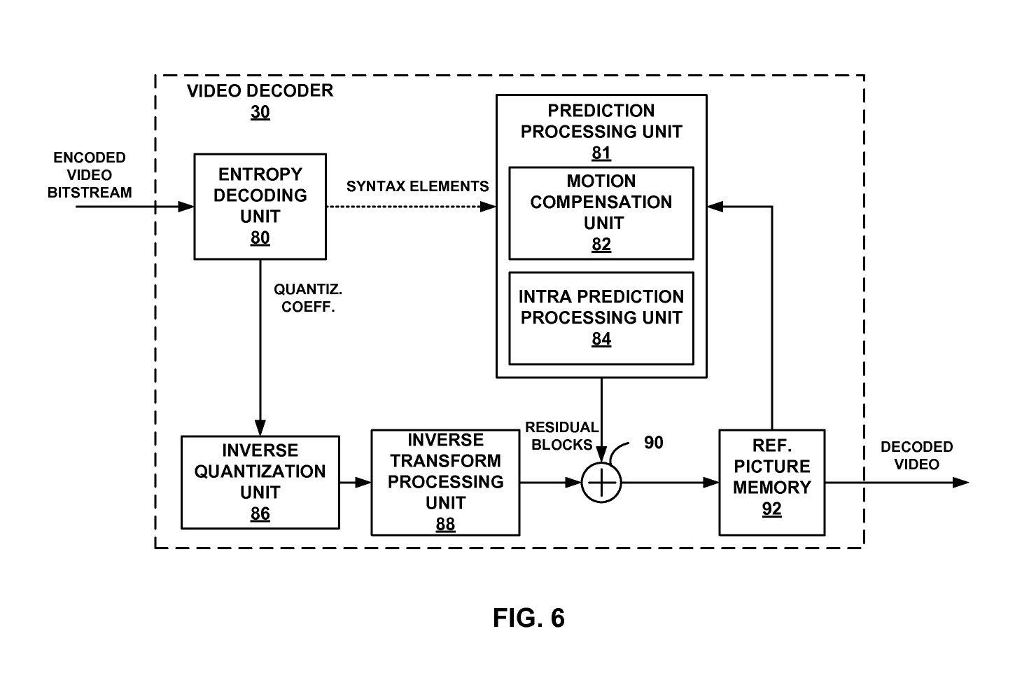

FIG. 6 is a block diagram illustrating an example video decoder 30 that may implement one or more of the techniques for motion vector prediction, motion compensation, and memory bandwidth reduction described in this disclosure. In the example of FIG. 6, video decoder 30 includes an entropy decoding unit 80, prediction processing unit 81, inverse quantization unit 86, inverse transformation unit 88, summer 90, and reference picture memory 92. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 5.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

As one example, motion vector, reference frame indices, and prediction direction may be determined by performing a motion vector prediction process (e.g., merge mode or AMVP mode). In this regard, motion compensation unit 82 may be configured to utilize a common reference frame index to perform motion vector prediction and motion compensation according to the techniques of this disclosure discussed above. A more detailed discussion of the function of motion compensation unit 82 is discussed below with reference to FIG. 8.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 31 of FIG. 1.

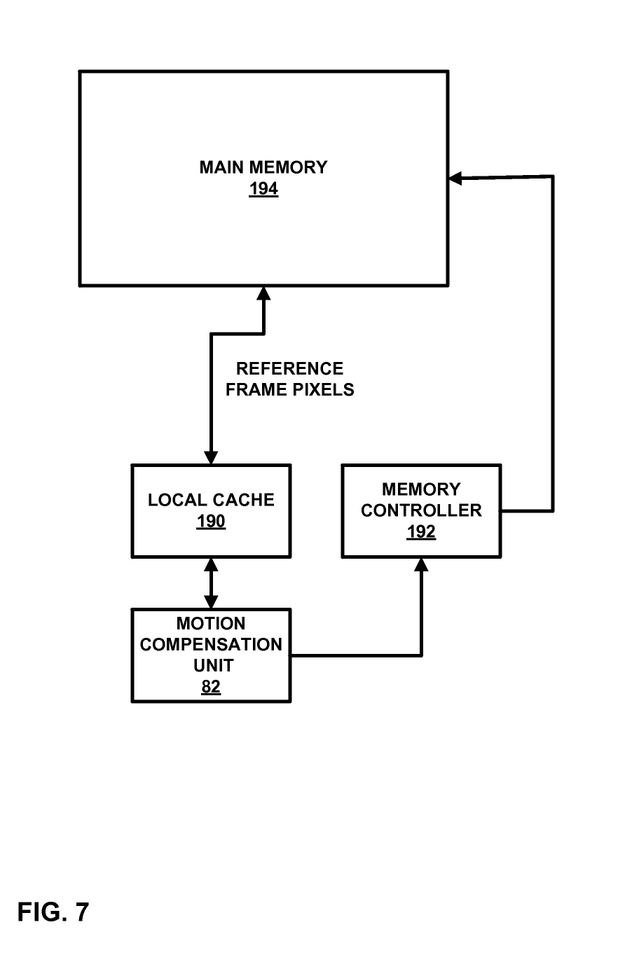

FIG. 7 is a block diagram showing an example memory structure according to one example of the disclosure. As shown in FIG. 7, motion compensation unit 82 of video decoder 30 may be configured to access reference frame pixels from local cache 190. In some situations, when performing motion compensation for a particular PU, the reference pixels specified by the related motion vector and reference frame index are not located in local cache 190. In this situation, motion compensation unit 82 (or another functional unit of video decoder 30) may be configured to instruct memory controller 192 to fetch the needed reference pixels from main memory 194 and store them in local cache 190. Repeated requests to fetch and store new reference frame pixels may slow the processing speed of video decoder and/or limit available memory bandwidth between main memory 194 and one or more local caches (e.g., local cache 190). By using the techniques discussed above to restrict the number of possible reference frame indices (e.g., to a common reference frame index), the techniques of this disclosure limit the number of possibly needed references frames at a given time during the decoding process, and thus, limit the number of fetch and store requests to main memory 194. As such, memory bandwidth use is reduced, which is desirable in many instances.

FIG. 8 is a flowchart showing an example method of video encoding and video decoding according to the techniques of the disclosure. The techniques of FIG. 8 may be performed by one or more functional units of video encoder 20, including motion compensation unit 44. The techniques of FIG. 8 may also be performed by one or more functional units of video decoder 30, including motion compensation unit 82.

In the example of FIG. 8, motion compensation unit 44 and motion compensation unit 82 may be configured to determine a plurality of motion vector candidates for a block of video data for use in a motion vector prediction process, wherein each of the motion vector candidates points to a respective reference frame index (800). Motion compensation unit 44 and motion compensation unit 82 may be further configured to perform the motion vector prediction process using the motion vector candidates to determine a motion vector for the block of video data (810).

In order to lower memory bandwidth requirements associated with accessing reference pixels in motion compensation process, motion compensation unit 44 and motion compensation unit 82 may be further configured to alter the respective reference frame index associated with a particular motion vector candidate to be a common reference frame index (820). In one example, motion compensation unit 44 and motion compensation unit 82 alter the respective reference frame index associated with a particular motion vector candidate to be the common reference frame index in the case that the particular motion vector candidate is from a spatially neighboring block relative to the block of video data being coded and that the respective reference frame index associated with the particular motion vector candidate is not the common reference frame index.

In addition to altering a particular reference frame index of a motion vector candidate to be the common reference frame index, motion compensation unit 44 and motion compensation unit 82 may optionally be further configured to alter a motion vector associated with the particular motion vector candidate (830). In one example, motion compensation unit 44 and motion compensation unit 82 alter a motion vector associated with the particular motion vector candidate by multiplying the motion vector by −1, in the case that the particular motion vector candidate has a reference frame index that points to a reference frame that is on an other side of a frame containing the block of video data relative to a reference frame associated with the common reference frame index.

In another example, motion compensation unit 44 and motion compensation unit 82 alter a motion vector associated with the particular motion vector candidate by scaling the motion vector relative to a temporal distance between a reference frame associated with the particular motion vector candidate and a reference frame associated with the common reference frame index. In still another example, motion compensation unit 44 and motion compensation unit 82 may perform no alteration a motion vector associated with the particular motion vector candidate.

Once any reference frame indices and/or motion vector have been altered, motion compensation unit 44 and motion compensation unit 82 may be further configured to perform motion compensation for the block of video data using the motion vector and the common reference frame index, wherein the common reference frame index is used regardless of the respective reference frame index associated with the determined motion vector (840). Performing motion compensation may include retrieving pixels from a reference frame indicated by the common reference frame index.

In the examples given above, the motion vector prediction process may be a merge mode motion vector prediction process and/or an advanced motion vector prediction (AMVP) process. In some examples, the common reference frame index is fixed and stored at video encoder 20 and video decoder 30. In other examples, video encoder 20 is configured to signal the common reference frame index in one or more of a picture header, a slice header, and an adaptation parameter set (APS). Likewise, video decoder 30 is configured to receive the common reference frame index in one or more of a picture header, a slice header, and an adaptation parameter set (APS).

The techniques of FIG. 8 may be applied to both uni-directional inter-prediction and b-direction inter-prediction. In one example, the common reference frame index is the same for reference frames used for both uni-directional inter-prediction and bi-directional inter-prediction. In another example, there may be two different common reference frame indices for bi-directional prediction. For example, the common reference frame index discussed above may be referred to as a first common reference frame index. The first common reference frame index being used for reference frames used for uni-directional inter-prediction. Furthermore, motion compensation unit 44 and motion compensation unit 82 may be further configured to additionally use a second common reference frame index for reference frames used for bi-directional inter-prediction.

In the examples of FIG. 8 discussed above, the block of video data being coded may be a prediction unit (PU), such as the PU defined by HEVC. In some examples, the techniques of FIG. 8 may be limited to PUs at some predetermined size. For example, the techniques of FIG. 8 may be limited to PUs having a size of 8×8 or smaller. In another example, the techniques of FIG. 8 may be further limited to PUs coded using an N×N inter prediction mode.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a plurality of motion vector candidates for a block of video data for use in a motion vector prediction process, wherein each of the motion vector candidates points to a respective reference frame index;
performing the motion vector prediction process using the motion vector candidates to determine a motion vector for the block of video data; and
performing motion compensation for the block of video data using the motion vector and a common reference frame index.

2. The method of claim 1, wherein performing motion compensation comprises:
retrieving pixels from a reference frame indicated by the common reference frame index.

3. The method of claim 2, wherein the motion vector prediction process is a merge mode motion vector prediction process.

4. The method of claim 2, wherein the motion vector prediction process is an advanced motion vector prediction process.

5. The method of claim 1, further comprising:
altering the respective reference frame index associated with a particular motion vector candidate to be the common reference frame index in the case that the particular motion vector candidate is from a spatially neighboring block relative to the block of video data and that the respective reference frame index associated with the particular motion vector candidate is not the common reference frame index; and
not altering a motion vector associated with the particular motion vector candidate.

6. The method of claim 1, further comprising:
altering the respective reference frame index associated with a particular motion vector candidate to be the common reference frame index in the case that the particular motion vector candidate has a reference frame index that points to a reference frame that is on an other side of a frame containing the block of video data relative to a reference frame associated with the common reference frame index; and
altering a motion vector associated with the particular motion vector candidate by multiplying the motion vector by −1.

7. The method of claim 1, further comprising:
altering the respective reference frame index associated with a particular motion vector candidate to be the common reference frame index in the case that the particular motion vector candidate has the respective reference frame index that is not the common reference frame index; and
altering a motion vector associated with the particular motion vector candidate by scaling the motion vector relative to a temporal distance between a reference frame associated with the particular motion vector candidate and a reference frame associated with the common reference frame index.

8. The method of claim 1, wherein the common reference frame index is fixed and stored at a video decoder.

9. The method of claim 1, wherein the common reference frame index is the same for reference frames used for both uni-directional inter-prediction and bi-directional inter-prediction.

10. The method of claim 1, wherein the common reference frame index is a first common reference frame index, the first common reference frame index being used for reference frames used for uni-directional inter-prediction, and wherein the method further comprises:
using a second common reference frame index for reference frames used for bi-directional inter-prediction.

11. The method of claim 1, further comprising:
receiving the common reference frame index in one or more of a picture header, a slice header, and an adaptation parameter set (APS).

12. The method of claim 1, wherein the block of video data is a prediction unit.

13. The method of claim 12, wherein the prediction unit has a size of 8×8 or smaller.

14. The method of claim 12, wherein performing motion compensation comprises performing motion compensation using an N×N inter prediction mode.

15. A method of encoding video data, the method comprising:
determining a plurality of motion vector candidates for a block of video data for use in a motion vector prediction process, wherein each of the motion vector candidates points to a respective reference frame index;
performing the motion vector prediction process using the motion vector candidates to determine a motion vector for the block of video data; and
performing motion compensation for the block of video data using the motion vector and a common reference frame index.

16. The method of claim 15, wherein performing motion compensation comprises:
retrieving pixels from a reference frame indicated by the common reference frame index.

17. The method of claim 16, wherein the motion vector prediction process is a merge mode motion vector prediction process.

18. The method of claim 16, wherein the motion vector prediction process is an advanced motion vector prediction process.

19. The method of claim 15, further comprising:
altering the respective reference frame index associated with a particular motion vector candidate to be the common reference frame index in the case that the particular motion vector candidate is from a spatially neighboring block relative to the block of video data and that the respective reference frame index associated with the particular motion vector candidate is not the common reference frame index; and
not altering a motion vector associated with the particular motion vector candidate.

20. The method of claim 15, further comprising:
altering the respective reference frame index associated with a particular motion vector candidate to be the common reference frame index in the case that the particular motion vector candidate has a reference frame index that points to a reference frame that is on an other side of a frame containing the block of video data relative to a reference frame associated with the common reference frame index; and
altering a motion vector associated with the particular motion vector candidate by multiplying the motion vector by −1.

21. The method of claim 15, further comprising:
altering the respective reference frame index associated with a particular motion vector candidate to be the common reference frame index in the case that the particular motion vector candidate has the respective reference frame index that is not the common reference frame index; and
altering a motion vector associated with the particular motion vector candidate by scaling the motion vector relative to a temporal distance between a reference frame associated with the particular motion vector candidate and a reference frame associated with the common reference frame index.

22. The method of claim 15, wherein the common reference frame index is fixed and stored at a video encoder.

23. The method of claim 15, wherein the common reference frame index is the same for reference frames used for both uni-directional inter-prediction and bi-directional inter-prediction.

24. The method of claim 15, wherein the common reference frame index is a first common reference frame index, the first common reference frame index being used for reference frames used for uni-directional inter-prediction, and wherein the method further comprises:
using a second common reference frame index for reference frames used for bi-directional inter-prediction.

25. The method of claim 15, further comprising:
signaling the common reference frame index in one or more of a picture header, a slice header, and an adaptation parameter set (APS).

26. The method of claim 15, wherein the block of video data is a prediction unit.

27. The method of claim 26, wherein the prediction unit has a size of 8×8 or smaller.

28. The method of claim 26, wherein performing motion compensation comprises performing motion compensation using an N×N inter prediction mode.

29. An apparatus configured to code video data, the apparatus comprising:
a video coder configured to:
determine a plurality of motion vector candidates for a block of video data for use in a motion vector prediction process, wherein each of the motion vector candidates points to a respective reference frame index;
perform the motion vector prediction process using the motion vector candidates to determine a motion vector for the block of video data; and
perform motion compensation for the block of video data using the motion vector and a common reference frame index.

30. The apparatus of claim 29, wherein the video coder is further configured to:
retrieve pixels from a reference frame indicated by the common reference frame index.

31. The apparatus of claim 30, wherein the motion vector prediction process is a merge mode motion vector prediction process.

32. The apparatus of claim 30, wherein the motion vector prediction process is an advanced motion vector prediction process.

33. The apparatus of claim 29, wherein the video coder is further configured to:
alter the respective reference frame index associated with a particular motion vector candidate to be the common reference frame index in the case that the particular motion vector candidate is from a spatially neighboring block relative to the block of video data and that the respective reference frame index associated with the particular motion vector candidate is not the common reference frame index; and
not alter a motion vector associated with the particular motion vector candidate.

34. The apparatus of claim 29, wherein the video coder is further configured to:
alter the respective reference frame index associated with a particular motion vector candidate to be the common reference frame index in the case that the particular motion vector candidate has a reference frame index that points to a reference frame that is on an other side of a frame containing the block of video data relative to a reference frame associated with the common reference frame index; and
alter a motion vector associated with the particular motion vector candidate by multiplying the motion vector by −1.

35. The apparatus of claim 29, wherein the video coder is further configured to:
alter the respective reference frame index associated with a particular motion vector candidate to be the common reference frame index in the case that the particular motion vector candidate has the respective reference frame index that is not the common reference frame index; and
alter a motion vector associated with the particular motion vector candidate by scaling the motion vector relative to a temporal distance between a reference frame associated with the particular motion vector candidate and a reference frame associated with the common reference frame index.

36. The apparatus of claim 29, wherein the common reference frame index is the same for reference frames used for both uni-directional inter-prediction and bi-directional inter-prediction.

37. The apparatus of claim 29, wherein the common reference frame index is a first common reference frame index, the first common reference frame index being used for reference frames used for uni-directional inter-prediction, and wherein the video coder is further configured to:
use a second common reference frame index for reference frames used for bi-directional inter-prediction.

38. The apparatus of claim 29, wherein the block of video data is a prediction unit.

39. The apparatus of claim 38, wherein the prediction unit has a size of 8×8 or smaller.

40. The apparatus of claim 38, wherein the video coder is further configured to perform motion compensation using an N×N inter prediction mode.

41. The apparatus of claim 29, wherein the video coder is a video decoder, the video decoder further configured to:
receive the common reference frame index in one or more of a picture header, a slice header, and an adaptation parameter set (APS).

42. The apparatus of claim 29, wherein the video coder is a video encoder, the video encoder further configured to:
signal the common reference frame index in one or more of a picture header, a slice header, and an adaptation parameter set (APS).

43. An apparatus configured to code video data, the apparatus comprising:
means for determining a plurality of motion vector candidates for a block of video data for use in a motion vector prediction process, wherein each of the motion vector candidates points to a respective reference frame index;
means for performing the motion vector prediction process using the motion vector candidates to determine a motion vector for the block of video data; and
means for performing motion compensation for the block of video data using the motion vector and a common reference frame index.

44. The apparatus of claim 43, further comprising:
means for retrieving pixels from a reference frame indicated by the common reference frame index.

45. The apparatus of claim 44, wherein the motion vector prediction process is a merge mode motion vector prediction process.

46. The apparatus of claim 43, further comprising:
means for altering the respective reference frame index associated with a particular motion vector candidate to be the common reference frame index in the case that the particular motion vector candidate is from a spatially neighboring block relative to the block of video data and that the respective reference frame index associated with the particular motion vector candidate is not the common reference frame index; and
means for not altering a motion vector associated with the particular motion vector candidate.

47. The apparatus of claim 43, further comprising:
means for altering the respective reference frame index associated with a particular motion vector candidate to be the common reference frame index in the case that the particular motion vector candidate has a reference frame index that points to a reference frame that is on an other side of a frame containing the block of video data relative to a reference frame associated with the common reference frame index; and
means for altering a motion vector associated with the particular motion vector candidate by multiplying the motion vector by −1.

48. The apparatus of claim 43, further comprising:
means for altering the respective reference frame index associated with a particular motion vector candidate to be the common reference frame index in the case that the particular motion vector candidate has the respective reference frame index that is not the common reference frame index; and
means for altering a motion vector associated with the particular motion vector candidate by scaling the motion vector relative to a temporal distance between a reference frame associated with the particular motion vector candidate and a reference frame associated with the common reference frame index.

49. A computer-readable storage medium storing instructions that, when executed, cause one or more processors of a device configured to code video data to:
determine a plurality of motion vector candidates for a block of video data for use in a motion vector prediction process, wherein each of the motion vector candidates points to a respective reference frame index;
perform the motion vector prediction process using the motion vector candidates to determine a motion vector for the block of video data; and
perform motion compensation for the block of video data using the motion vector and a common reference frame index.

50. The computer-readable storage medium of claim 49, wherein the instructions further cause the one or more processors to:
retrieve pixels from a reference frame indicated by the common reference frame index.

51. The computer-readable storage medium of claim 50, wherein the motion vector prediction process is a merge mode motion vector prediction process.

52. The computer-readable storage medium of claim 49, wherein the instructions further cause the one or more processors to:
alter the respective reference frame index associated with a particular motion vector candidate to be the common reference frame index in the case that the particular motion vector candidate is from a spatially neighboring block relative to the block of video data and that the respective reference frame index associated with the particular motion vector candidate is not the common reference frame index; and
not alter a motion vector associated with the particular motion vector candidate.

53. The computer-readable storage medium of claim 49, wherein the instructions further cause the one or more processors to:
alter the respective reference frame index associated with a particular motion vector candidate to be the common reference frame index in the case that the particular motion vector candidate has a reference frame index that points to a reference frame that is on an other side of a frame containing the block of video data relative to a reference frame associated with the common reference frame index; and
alter a motion vector associated with the particular motion vector candidate by multiplying the motion vector by −1.

54. The computer-readable storage medium of claim 49, wherein the instructions further cause the one or more processors to:
alter the respective reference frame index associated with a particular motion vector candidate to be the common reference frame index in the case that the particular motion vector candidate has the respective reference frame index that is not the common reference frame index; and
alter a motion vector associated with the particular motion vector candidate by scaling the motion vector relative to a temporal distance between a reference frame associated with the particular motion vector candidate and a reference frame associated with the common reference frame index.
